(19) United States
(12) Patent Application Publication
(10) Pub. No.: US 2007/0089258 A1
(43) Pub. Date: Apr. 26, 2007

(54) Heated windshield wiper system

(76) Inventor: Bart Jeffrey Wick, Eagle River, WI (US)

Correspondence Address: David O. Simmons;Galasso & Associates LP, P.O. Box 26503, Austin, TX, 78755-0503, US

(21) Appl. No.: 11/254,995

(22) Filed: Oct. 20, 2005

(51) Int. Cl. B60S 1/38

(52) U.S. Cl. 15/250.06; 15/250.05; 219/202

(57) ABSTRACT

A heated windshield wiper system comprises an electrical control circuit, an activation switch and a windshield wiper blade including an electrical heating element. The electrical control circuit is coupled to the electrical heating element and includes timing circuitry configured for allowing a user to select a period of time from a plurality of user-selectable periods of time for which electrical current is provided to the electrical heating element. The activation switch is connected to the timing circuitry and enables power to be supplied to the electrical heating element. The timing circuitry is set to a specified one of said user-selectable periods of time when the activation switch is moved to a position for providing power to the electrical heating element. The electrical control circuit includes a temperature sensing device and the specified one of said user-selectable periods of time is dependent upon a temperature sensed by the temperature sensing device.

### FIELD OF THE DISCLOSURE

The disclosures made herein relate generally to vehicle windshield wiper systems and, more particularly, to heated windshield wiper blades and systems.

### BACKGROUND

A windshield wiper apparatus is a valuable safety apparatus for a vehicle such as a car or truck. Without effective performance of such a windshield wiper apparatus, visibility is generally dramatically impaired when driving a vehicle in inclement conditions. Examples of such inclement weather conditions include rain, snow, sleet, and fog.

Temperatures below freezing, whether ambient temperature or wind-induced temperature, can present especially dangerous driving conditions. When accompanied by snow or rain, such below freezing temperatures can result in ice forming on the windshield of a car. Additionally, even in dry conditions, applying typical windshield washing solutions using a vehicle's windshield wash system can lead to an immediate icing of the windshield and wiper blades, particularly when the interior of the vehicle is near or below freezing temperatures.

Regardless of the source of liquid, such formation of ice on a windshield impairs visibility and adversely impacts the performance of a conventional windshield wiper apparatus of a vehicle. The adverse impact on the performance of the vehicle's windshield wiper apparatus compounds the undesirable condition of ice forming on the vehicle's windshield and wiper blades. The end result is either an exceedingly dangerous driving situation or the inconvenience of having to manually remove the ice from the windshield and wiper blades.

Heated windshield wiper blade systems are known and are referred to herein as conventional heated windshield wiper blade systems. Conventional heated windshield wiper systems include a windshield wiper blade, a resistive heating element in combination with the windshield wiper blade and electrical control circuitry connected for providing electrical current to the resistive heating element. Examples of such conventional heated windshield wiper systems are disclosed in U.S. Pat. Nos. 6,236,019; 6,028,291; 5,841,106; 5,832,558; 5,649,337; 5,325,561; 4,670,933 and 4,603,451.

The electrical control circuitry of conventional heated windshield wiper systems are configured for controlling the supply of electrical current through the use of a manual on-off switch, a thermostatic device and/or a fixed-duration timer. As such, conventional heated windshield wiper systems are limited in that they do not allow a motorist and/or a system element to choose the duration of time that electrical current is provided to the resistive heating element. In some instances and/or climates, the ability to choose select from a plurality of different user selectable periods of time for which electrical current is supplied to the resistive heating element is useful. Therefore, a windshield wiper system that allows a motorist to selectively determine a period of time for which electrical current is supplied to a resistive heating element of a windshield wiper blade would be advantageous and useful.

### SUMMARY OF THE DISCLOSURE

Embodiments of the present invention provide for improved effectiveness of heated windshield wipers. More specifically, embodiments of the present invention provide for electrical current to be provided to an electrical heating element of a wiper blade for a plurality of different selectable periods of time. For example, a motorist may select a period of time for which electrical current is provided to the electrical heating element dependent upon present ambient conditions and/or driving conditions. In doing so, embodiments of the present invention advantageously overcome one or more limitations associated with conventional heated windshield wiper systems.

In one embodiment of the present invention, a heated windshield wiper system comprises a windshield wiper blade and an electrical control circuit. The windshield wiper blade includes an electrical heating element. The electrical control circuit is coupled to the electrical heating element. The electrical control circuit includes timing circuitry configured for allowing a user to select a period of time from a plurality of user-selectable periods of time for which electrical current is provided to the electrical heating element.

In another embodiment of the present invention, a heated windshield wiper system comprises a windshield wiper blade and an electrical control circuit. The windshield wiper blade includes an electrical heating element. The electrical control circuit is coupled to the electrical heating element and includes timing circuitry and an activation switch. The timing circuitry is configured for allowing a user to select a period of time from a plurality of user-selectable periods of time for which electrical current is provided to the electrical heating element. The activation switch is connected to the timing circuitry and enables power to be selectively supplied to the electrical heating element. The timing circuitry is set to a specified one of the user-selectable periods of time when the activation switch is moved to a position enabling power to be supplied to the electrical heating element.

In another embodiment of the present invention, a heated windshield wiper system comprises a windshield wiper blade and a timer-relay. The windshield wiper blade includes an electrical heating element. The timer-relay is electrically coupled to the electrical heating element. The timer-relay has a plurality of selectable time settings for which electrical current is provided through the timed relay to the electrical heating element.

Turning now to specific aspects of the present invention, in at least one embodiment, the electrical heating element is a resistive heating element.

In at least one embodiment of the present invention, the electrical heating element is an elongated electrical heating element embedded in a resilient body of the windshield wiper blade.

In at least one embodiment of the present invention, the electrical control circuit includes a temperature sensing device and the specified one of the user-selectable periods of time is dependent upon a temperature sensed by the temperature sensing device.

In at least one embodiment of the present invention, the plurality of user selectable periods of time consists of a plurality of pre-defined periods of time.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts an embodiment of a heated windshield wiper system in accordance with the present invention.

FIG. 2 depicts an embodiment of a heated windshield wiper assembly in accordance with the present invention.

FIG. 3 depicts an embodiment of a heated windshield wiper blade in accordance with the present invention.

### DETAILED DESCRIPTION OF THE DRAWING FIGURES

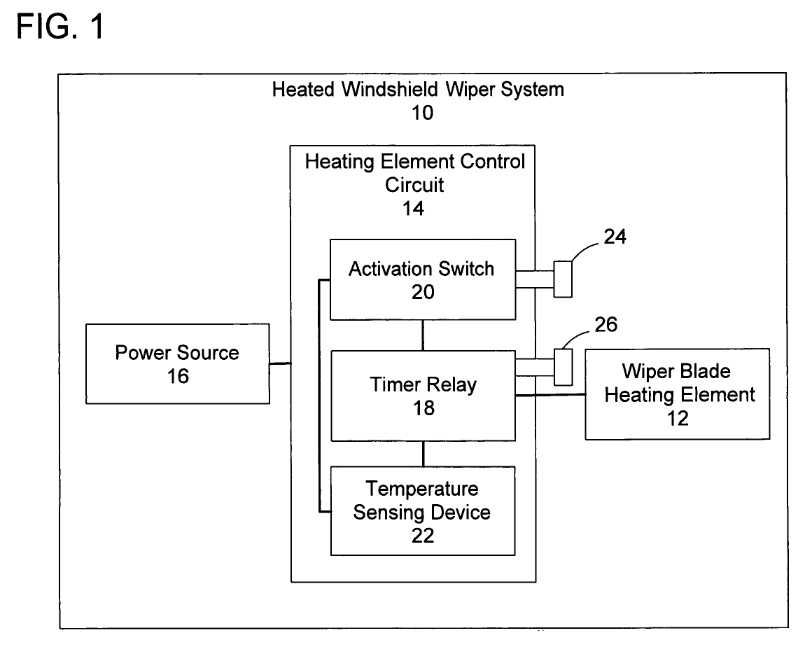

FIG. 1 depicts an embodiment of a heated windshield wiper system in accordance with the present invention, which is referred to herein as the heated windshield wiper system 10. The heated windshield wiper system 10 comprises a wiper blade heating element 12, a heating element heating element control circuit 14 and power source 16. The wiper blade heating element 12 is connected to the heating element heating element control circuit 14 and to the power source 16. For example, as depicted in FIG. 1, the wiper blade heating element 12 is connected directly to the heating element heating element control circuit 14 and is connected to the power source 16 through the heating element control circuit 14. A main battery of an automobile and a dedicated battery for the heated windshield wiper system are two examples of the power source 16.

The heating element control circuit 14 is an example of an electrical control circuit in accordance with the present invention and includes a timer-relay 18, an activation switch 20 and a temperature sensing device 22. The timer-relay 18 is connected between the activation switch 20 and the temperature sensing device 22. The timer-relay 18 is a specific embodiment of timing circuitry configured for allowing a user to select a period of time from a plurality of user-selectable periods of time for which electrical current is provided to the wiper blade heating element 12. Examples of such user-selectable periods of time are pre-defined (i.e., discrete) time periods such as 30 seconds, 1 minute, 2 minutes and 5 minutes. It is disclosed herein that the timing circuitry may be of a solid-state arrangement and/or include electromechanical components such as, for example, a mechanical relay. It is further disclosed herein that the timer-relay may apply electrical current for the selected period of time and remove the electrical current for a prescribed period of time (e.g., the same or different than the selected period of time) in an alternating manner, continually or for a prescribed number of cycles.

In the depicted embodiment of the timer-relay 18, the timer-relay 18 includes a selection device 24 (e.g., a knob or switch) that is accessible by a user and that enables manual selection of at least a portion of the plurality of user-selectable periods of time for which electrical current is provided to the wiper blade heating element 12. Similarly, in the depicted embodiment of the activation switch 20, the activation switch 20 includes a selection device 26 (e.g., a knob or switch) that is accessible by a user and that enables manual selection of a power enable condition (i.e., electrical current supplied to the timer-relay 18) and a power disable condition (i.e., electrical current not supplied to the timer-relay 18).

In at least one embodiment of the present invention, the timer-relay 18 is set to a specified (e.g., a default) one of the user-selectable periods of time (e.g., a shortest period of time) when the activation switch 20 is moved to a position enabling power to be supplied to the wiper blade heating element 12. Thereafter, the selection device 24 of the timer-relay may be manipulated for selecting a greater or lesser period of time. It is disclosed herein that, in embodiments of the present invention, the activation switch 20 may be implemented in a manner whereby it solely enables power to be supplied to the timer-relay 18 without any associated default time period functionality.

The temperature sensing device 22 (e.g., a thermostatic device, a thermistor device or the like) senses an exterior temperature condition (e.g., ambient temperature and/or ambient temperature corrected for wind chill). In one embodiment of the present invention, the temperature sensing device 22 outputs a corresponding signal (e.g., a proportional signal voltage) to the timer-relay 18 and the timer-relay 18 utilizes that signal for determining and/or setting a period of time for which electrical current is provided to the wiper blade heating element 12. In another embodiment of the present invention, upon the sensed temperature reaching a prescribed level (e.g., below freezing), the temperature sensing device 22 outputs an activation signal (e.g., a signal voltage of a prescribed level) to the timer-relay 18 or, optionally, the activation switch for causing electrical current to be supplied to the wiper blade heating element 12.

It is disclosed herein that embodiments of the present invention may be implemented without the temperature sensing device 22 and its associated functionality. In such embodiments, the heated windshield wiper system would operate solely based on selection of one of a plurality of user selectable periods of time for which power is supplied to the wiper blade heating element 12.

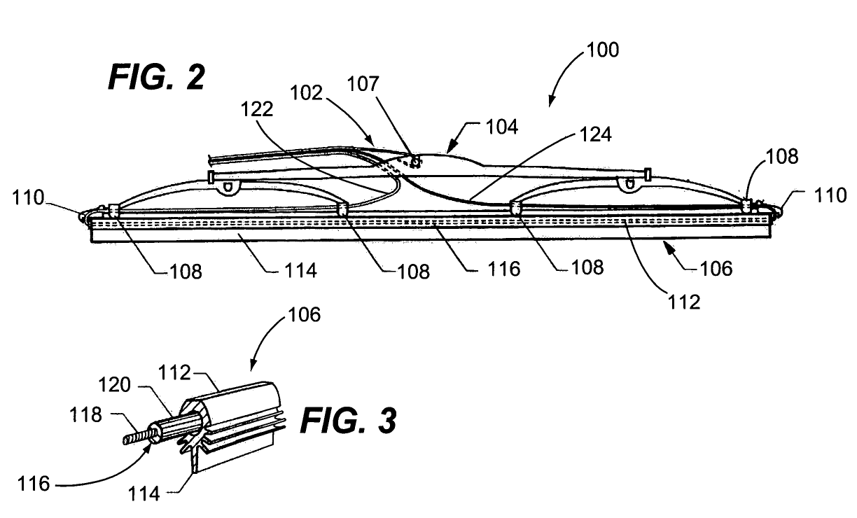

Turning now to FIG. 2, an embodiment of a wiper blade assembly in accordance with the present invention is depicted, which is referred to herein as the wiper blade assembly 100. The wiper blade assembly 100 includes a wiper blade arm 102, a wiper blade frame 104 and a heated wiper blade 106. The wiper blade arm 102 is attached in a conventional manner to a wiper blade motor (not shown) for enable movement of the wiper blade apparatus 100 over a windshield and is pivotally attached to a pivot pin 107 of the wiper blade frame 104. The heated wiper blade 106 is attached to the wiper blade frame 104 via slideable engagement with a plurality of attachment members 108. Retention clips 110 at opposing ends of the wiper blade frame 104 limit longitudinal displacement of the heated wiper blade 106 with respect to the wiper blade frame 104.

Referring now to FIGS. 2 and 3, the heated wiper blade 106 includes a resilient body 112 having a main wiping edge 114. The resilient body 112 is made from a resilient polymeric material such as, for example, synthetic rubber. An electrical heating element 116 resides within the resilient body 112 (e.g., is embedded within in an over-molding process). Preferably, but not necessarily, the electrical heating element 116 is an elongated resistive heating element including a resistive heating core 118 and a flexible sheath 120. As depicted in FIG. 2, a first electrical conductor 122 and a second electrical conductor 124 are connected to the electrical heating element 116 (i.e., to the resistive heating core 118). The electrical heating element 116 is an embodiment of the wiper blade electrical heating 12 depicted in FIG. 1. Accordingly, the first electrical conductor 122 and the second electrical conductor 124 enable electrical current to be supplied to the electrical heating element 1 such as via the heating element control circuit 14 depicted in FIG. 1. It is disclosed herein that the present invention is not limited to a specific configuration of heated wiper blade and that a heated wiper blade construction other than that depicted in FIG. 3 may be readily implemented.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A heated windshield wiper system, comprising:
a windshield wiper blade including an electric heating element; and
an electrical control circuit coupled to the electrical heating element, wherein the electrical control circuit includes timing circuitry configured for allowing a user to select a period of time from a plurality of user selectable periods of time for which electrical current is provided to the electrical heating element;
wherein the plurality of user selectable periods of time consist of a plurality of pre-defined periods of time.

2. The heated windshield wiper system of claim 1 wherein the electrical heating clement is a resistive heating element.

3. The heated windshield wiper system of claim 1 wherein the electrical heating element is an elongated electrical heating element embedded in a resilient body of the windshield wiper blade.

4. (canceled)

5. The heated windshield wiper system of claim 4 wherein:
the electrical heating element is a resistive heating element; and
the electrical heating element is an elongated electrical heating element embedded in a resilient body of the windshield wiper blade.

6. A heated windshield wiper system, comprising:
a windshield wiper blade including an electrical heating element;
an electrical control circuit coupled to the electrical heating element, wherein the electrical control circuit includes timing circuitry and an activations switch,
wherein the timing circuitry is configured for allowing a user to select a period of time from a plurality of user-selectable periods of time for which electrical current is provided to the electrical heating element, wherein the activation switch for enabling power to be selectively supplied to the electrical heating element, wherein the activation switch is connected to the timing circuitry,
wherein the timing circuitry is set to a specified one of said user-selectable periods of time when the activation switch is moved to a position enabling power to be supplied to the electrical heating element;
wherein the electrical control circuit includes a temperature sensing device configured to output a signal proportional to sensed temperature; and
the specified one of said user-selectable periods of time is dependent upon a temperature sensed by the temperature sensing device.

7. The heated windshield wiper system of claim 6 wherein the electrical heating element is a resistive heating element.

8. The heated windshield wiper system of claim 6 wherein the electrical heating element is an elongated electrical heating element embedded in a resilient body of the windshield wiper blade.

9. (canceled)

10. The heated windshield wiper system of claim 6 wherein the plurality of user selectable periods of time consists of a plurality of pre-defined periods of time.

11. The heated windshield wiper system of claim 6 wherein:
the electrical heating element is a resistive heating element;
the electrical heating element is an elongated electrical heating element embedded in a resilient body of the windshield wiper blade;
the plurality of user selectable periods of time consists of a plurality of predefined periods of time;
the electrical control circuit includes a temperature sensing device; and
the specified one of said user-selectable periods of time is dependent upon a temperature sensed by the temperature sensing device.

12. A heated windshield wiper system, comprising:
a windshield wiper blade including an electrical heating element; and
a timer-relay electrically coupled to the electrical heating element, wherein the timer-relay has a plurality of selectable time settings for which electrical current is provided through the timed relay to the electrical heating element;
wherein the plurality of selectable time settings consist of a plurality of pre-defined time settings; and
wherein a temperature sensing device is configured to output a signal proportional to sensed temperature to said timer relay.

13. The heated windshield wiper system of claim 12 wherein the electrical heating element is a resistive heating element.

14. The heated windshield wiper system of claim 12 wherein the electrical heating element is an elongated electrical heating element embedded in a resilient body of the windshield wiper blade.

15. The heated windshield wiper system of claim 12 wherein:
the specified one of said user-selectable periods of time is dependent upon the temperature sensed by the temperature sensing device.

16. The heated windshield wiper system of claim 12 wherein the plurality of selectable time settings consist of a plurality of pre-defined time settings.

17. The heated windshield wiper system of claim 12 wherein:
the plurality of selectable time settings consist of a plurality of pre-defined time settings;
the electrical heating element is a resistive heating element;
the electrical heating element is an elongated electrical heating element embedded in a resilient body of the windshield wiper blade; and
the specified one of said user-selectable periods of time is dependent upon a temperature sensed by the temperature sensing device.
